(19) United States
(12) Patent Application Publication
(10) Pub. No.: US 2010/0093559 A1
(43) Pub. Date: Apr. 15, 2010

(54) Microfluidic Array Device and System for Simultaneous Detection of Multiple Analytes

(76) Inventors: Zhonghui Fan, Gainesville, FL (US); Toshikazu Nishida, Gainesville, FL (US)

Correspondence Address: Beusse Wolter Sanks Mora & Maire, 390 N. ORANGE AVENUE, SUITE 2500, ORLANDO, FL, 32801, US

(21) Appl. No.: 12/527,574

(22) PCT Filed: Mar. 27, 2008
(86) PCT No.: PCT/US08/58392

§ 371 Date: Aug. 25, 2009

(51) Int. Cl. C40B 30/04; C40B 60/12

(52) U.S. Cl. 506/9; 506/39

(57) ABSTRACT

(A1+A3, B1−B3, C1−C3) Disclosed herein are microfluidic devices having an array of microfluidic valves and other components to meet the requirement of an antibody array for analyte detection. The microfluidic valves disclosed herein enable simultaneous detection of multiple analytes in a sample. One embodiment exemplified herein pertains to a microarray that is in the format of a sandwich assay, each of which comprises a capture antibody, analyte, and secondary detection antibody conjugated with a fluorescent dye or an enzyme or another moiety to facilitate detection. Methods of using microfluidic valves in an array for simultaneously detecting multiple analytes is also disclosed.

### RELATED APPLICATIONS

This application claims priority to U.S. Ser. No. 60/908,444 filed Mar. 28, 2007, which is incorporated herein in its entirety.

### BACKGROUND

Detection and identification of toxic agents are important for medical diagnostics, food/water safety testing, and biological warfare defense. The prevalent detection methods are polymerase chain reaction (PCR) and immunoassay based on antigen-antibody interactions. The PCR-based genetic analysis offers high sensitivity and unambiguous identification of microorganisms such as bacteria, from which nucleic acids can be extracted for amplification. The immunoassay-based approaches are more suitable for toxin detection, since most toxins available in nature are proteins. An individual immunoassay detects only one analyte per test. However, the one-analyte-per-test immunoassay is inefficient for the requirement to detect a spectrum of analytes. For instance, a variety of bioterrorism toxins, including botulinum toxin, ricin, cholera toxin, and Staphylococcus aureus enterotoxin B, should be monitored in foods and other samples. Therefore, an approach to detect them rapidly and simultaneously will be an ideal platform for better efficiency and lower cost.

One of the critical components to realize the controlled manipulation of fluids in microsystems is microvalves. An array of microvalves is required for large-scale integration of microfluidic components; they are needed for containing fluids, directing flows, and isolating one region from others in the microfluidic array. However, creation of reliable valves in a microfluidic device is quite challenging due to the scaling laws.^{1,2}. Anderson et al.¹ used diaphragm and hydrophobic vents to isolate DNA amplification chambers, which were also employed by Legally et al.² Others exploited the phase change of a material; examples include freezing and melting of a fluid³ or paraffin⁴⁻⁶. Quake's group invented elastic membrane valves in multilayer structures while actuation of valves was achieved by vacuum and pressure^{7,8} Localized gel valves have also been explored for isolation of a DNA amplification region from an electrophoresis channel⁹ and for flow control inside microfluidic channels.¹⁰ In addition, many valves exist in the literature that were fabricated using traditional silicon-based MEMS (microelectromechanical systems) techniques, which are often not compatible to the manufacturing processes of commercial microfluidic devices that are based on glass or plastics. For those valves made in polydimethylsiloxane-based devices, the overall device fabrication could be difficult in industrial settings. For those valves using vacuum and pressure as the actuation mechanism, the operation could be very cumbersome to users and the actuation mechanism is difficult to be integrated in a device.

### BRIEF DESCRIPTION OF THE DRAWINGS

FIG. 1. Top view of a 3×3 multiplexed fluidic array for toxin detection. Valves are illustrated in FIG. 2. See the text for the detail.

FIG. 2. Cross-sectional view of a microfluidic valve in FIG. 1. The valve is off (open) on the left and on (closed) on the right. The valve can be switched on and off by an integrated heater.

FIG. 3. Cross-sectional view of a microfluidic valve in FIG. 1. The valve is off (open) on the left and on (closed) on the right. The valve can be switched on and off by an electronic current that passes through an electroelastic material.

### DETAILED DESCRIPTION

Certain embodiments of the subject invention are based on the inventors discovery and development of microfluidic valves that are manufacturable and compatible with a printed circuit board (PCB) and packaging technology currently used in the semiconductor and computer industry. The valves are actuated by microfabricated thermal resistors and a temperature-sensitive reagent, thus being reliable, easy to operate, and compatible to various fluidic components. The thermal-sensitive reagent includes fluids, gels, solids, and other thermal-response materials.

In addition to thermal actuation, valves can be actuated piezoelectric motion, electroactive polymers, electrostatic attraction, and other current-driven and voltage-driven mechanisms.

Compared to microplates or conventional protein arrays, microfluidic array devices and methods taught herein offer many advantages, including, but not limited to, short analysis time due to rapid interactions in the confined areas, reduced false positives from reagent contamination because of the physical separation by valves and channels, and minimum cost without the requirement for expensive equipment to pattern proteins. In addition, miniaturization provides other advantages including minimization of required sample and reagents.

Although this invention is illustrated by detecting multiple toxic agents, the method can easily be used by those who are skilled in the art for detection of other analytes. The analytes include proteins, antigens, ligands, and other analytes recognized by immunological interactions; deoxyribonucleic acids (DNA), ribonucleic acids (RNA), and the like recognized by complimentary nucleic acids; the compounds recognized by aptamers, peptides, carbohydrates and glycosphingolipids; and biological cells, particles, and the materials recognized by these specific interactions.

Some of the aspects of the subject invention involve:

Large-scale integration of an array of microfluidic valves with other components. These valves are fabricated using micromachining and molding, and actuated by microfabricated thermal resistors, electroelastic expansion, or other electronically actuated motion. Other integrated components may include thermal-sensitive materials, electroelastic materials, and temperature sensors.

Custom-micromachined PCB compatible to an array of microfluidic valves and temperature sensors. The PCB is hybrid-packaged with the device and an electronic interface for rapid analyte detection. In one embodiment, the heater and temperature sensor may be integrated in the PCB layer which is laminated to the microfluidic array. The PCB also contains interface electronics that deliver the actuation signal to the microvalve actuator and measure the sensing signal such as temperature in order to realize closed-loop and open-loop modes of operation.

Implementation of microfluidics-enabled, antibody microarray for detection of analytes. The microarray is in the format of a sandwich assay, each of which comprises a capture antibody, analyte, and secondary detection antibody conjugated with a fluorescent dye or an enzyme or another moiety to facilitate detection.

In certain embodiments, the subject invention provides a high-throughput approach to detect a spectrum of analytes such as toxins. With the potential use of biological weapons against American citizens and assets, the ability to simultaneously screen a large number of samples and detect a wide range of agents has become essential. Secondly, embodiments of the invention offer a unique method for large-scale integration of microfluidic components. The method offers a manufacturable process that allows mass production and leads to low-cost, disposable devices.

Microfluidics. Microfluidics technology has been used to construct miniaturized analytical instruments called “Lab-on-a-chip” devices. In analogy to shrinking a computer in the size of a room in 1950's to a laptop today, instruments for chemical and biological analyses may be miniaturized using modern microfabrication technology. The principles of microfabrication and microfluidics, as well as their current and potential applications, have been reviewed in the literature.^{11,12} Common analytical assays, including PCR, protein analysis, DNA separations, and cell manipulations have been reduced in the size and fabricated in a centimeter-scale chip. The size reduction of an analytical instrument has many advantages including high speed of analysis, minimization of required sample and reagents, and ability to operate in a high-throughput format.

We have previously reported fabricating a variety of microfluidic devices for applications including synthesis of a library of compounds for combinatorial chemistry,¹³ DNA hybridization for studying gene expression,¹⁴ DNA sequencing,^{15,16} protein separation,¹⁷⁻¹⁹ and bacterial detection.⁹

Printed circuit board and large-scale integration. Case studies of successful micromachined sensors indicate the importance of concurrent design of the sensor and the package.²⁰ Unlike conventional integrated circuits where nearly all packages are readily available and standardized for routing electrical signals, packages for sensors often require custom designs for the specific analyte and operation conditions. To address this, the prevalent approach is to partition the sensor into modules.²⁰ The modular approach results in hybrid sensor systems where each partition is fabricated using the optimal fabrication techniques for the specific module. For example, the microfluidics module is fabricated using chemically resistant plastics while the electronics module is designed using commercially available integrated circuit components. This results in greater flexibility, lower cost, and higher overall performance than integrating all functionality in a single monolithic fabrication process. Further integration is possible using the printed circuit board (PCB) approach, as it has been employed for hybrid electronic systems to integrate multiple electronic functions. The same PCB approach may be used for hybrid sensor arrays by connecting multiple sensors with electronics (for example, pre-amplifier and analog-to-digital conversion). We have previously demonstrated a sixteen micromachined acoustic transducer array²¹ using micromachined piezoresistive microphones mounted on a custom PCB. Furthermore, the same PCB may be used as the capping layer for the microfluidic assembly, simultaneously delivering the control signals and recording the sensed signals while also sealing the cavity containing the thermoelastic material.

Toxin detection. The potential use of biological weapons against American citizens and assets is one of the most disturbing threats facing the United States today. For instance, Ricin, a Category B agent defined by the Centers for Disease Control and Prevention (CDC),²² was the toxin sent in a letter to the US Congress in February 2004. Thus a compelling need exists to develop novel techniques for rapid and accurate detection of biological toxins.

### Example 1

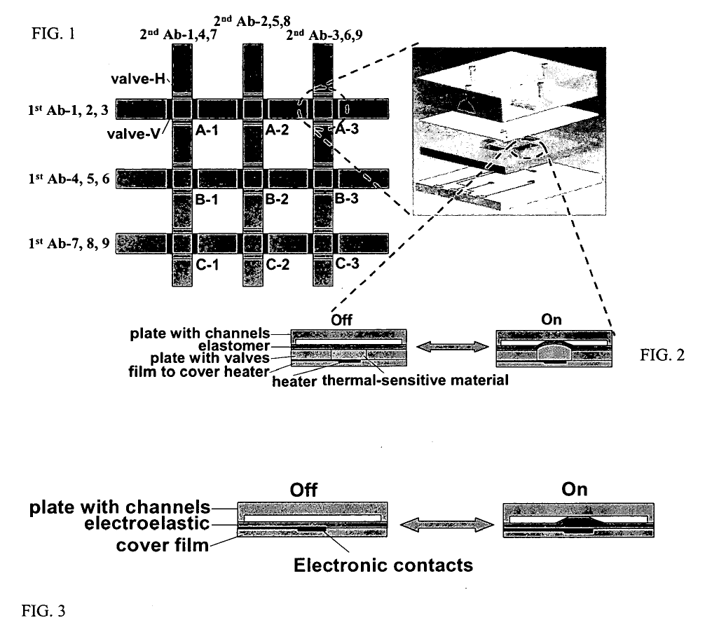

One embodiment relates to an array of microfluidic valves and other components to meet the requirement of an antibody array for analyte detection. The microfluidic valves in this invention will enable simultaneous detection of multiple analytes in a sample. The concept is illustrated in a 3×3 array in FIG. 1, though an array of a higher number can be implemented as is readily appreciated by those skilled in the art, in view of the teachings herein. Three horizontal channels are for introducing the primary antibodies. At the channel intersections, microfluidic valves (valve-H) indicated by horizontal bars will be closed, so that antibody solution will not flow into vertical channels. In horizontal channel 1, three antibodies (1^{st} Ab-1, 1^{st} Ab-2, and 1^{st} Ab-3) are introduced. Everywhere in this channel will be immobilized with these three antibodies. These antibodies are specific to antigen-1, -2, and -3. Immobilization can be achieved by the methods such as biotin-strepavidin chemistry or other surface modification schemes. Similarly, three different antibodies (1^{st} Ab-4, 1^{st} Ab-5, and 1^{St} Ab-6) specific to antigen-4, -5, and -6 are introduced in horizontal channel 2. And three other antibodies (1^{st} Ab-7, 1^{St} Ab-8, and 1^{St} Ab-9) specific to antigen-7, -8, and -9 are introduced in horizontal channel 3.

After washing all channels, a sample is pumped into all of three vertical channels. At the channel intersections, microfluidic valves (valve-V) indicated by vertical bars will be closed, so that the solution will not flow into horizontal channels. The nine analytes of interest should be captured in the corresponding intersections. For instance, intersections A-1, A-2, and A-3 capture only antigen-1, -2 and -3 if they are present. After washing these channels, three secondary antibodies (2^{nd} Ab-1, 2^{nd} Ab-4, and 2^{nd} Ab-7) specific to antigen-1, -4, and -7 are introduced in vertical channel 1. Similarly, three different antibodies (2^{nd} Ab-2, 2^{nd} Ab-5, and 2^{nd} Ab-8) specific to antigen-2, -5, and -8 are introduced in vertical channel 2. And three other antibodies (2^{nd} Ab-3, 2^{nd} Ab-6, and 2^{nd} Ab-9) specific to antigen-3, -6, and -9 are introduced in vertical channel 3. After appropriate detection reagents are applied, a signal at each location tells specifically the corresponding antigen present in the sample. For example, a signal in the intersection B-1 indicate the presence of antigen-4 in the sample, since the 1^{St} Ab-4 is contained in the horizontal channel 2 and the 2^{nd} Ab-4 is in the vertical channel 1. Other intersections have not been exposed to both 1^{St} Ab-4 and 2^{nd} Ab-4, thus any signal at other intersections has nothing to do with antigen-4.

The operation of microfluidic valves is illustrated in FIG. 2. The cross-sectional view shows one channel in a top plate, which is sealed with an elastomer film. A bottom plate with a through-hole (well) is then laminated to the elastomer. The well is for storage of a temperature-sensitive reagent; and it is sealed with a cover film that is patterned with a resistor and electric contact. When electric current flows through the resistor, the generated heat expands the volume of the reagent, stretching the elastomer to close the channel. Examples of thermally sensitive reagents include Fluorinert® from 3M and hydrogel,²³ some of which are able to achieve 1:1 swelling over a temperature change of only 10° C. As a result, such a thermally-actuated microfluidic valve should be easy to operate and reliable.

An alternative valve actuation is illustrated in FIG. 3. The cross-sectional view shows one channel in a top plate, which is sealed with a cover film with an electroelastic material. When an electronic contact and wire printed on the cover film is supplied with a current, the electrostatic material expands and blocks the channel. Some electroelastic materials have been used for artificial muscle. Other materials that are capable of expansion and contraction can also be used in this invention.

### Example 2

Device Fabrication. The materials used for making microfluidic devices include silicon, glass, and plastics, as reviewed.²⁴ We will choose plastics for this invention because of the following reasons. First, a wide range of plastics are available to be selected for a biological assay of interest. The compatibility between plastics and chemical/biological reagents is evident from the fact that many labwares such as microcentrifuge tubes and microplates are made of plastics. Plastic parts made by techniques such as injection molding or embossing can be quite inexpensive: the manufacturing cost of an injection-molded compact disc (CD), a two-layer structure containing micron-scale features, is presently less than 40¢.¹⁶ Therefore, plastic microfluidic devices can be made so cheap that they can be disposable after a single use. This could have tremendous impact in applications where cross-contamination of sequential samples is of concern. In alternative embodiments, devices will be fabricated following methods described previously,²⁵ though modification and optimization are carried out to meet the requirements.

In one embodiment, each module is fabricated using the appropriate technology for the required performance at low cost. Specifically, the microfluidics-based detection system are partitioned into microfluidics module, interconnects to microvalve heaters, and electronic addressing and control. The microfluidic channels and microvalves are fabricated as discussed above. The heaters, interconnects, and other components are micromachined directly on the plastic substrate using patterned thin film metal or using thin film deposited on a thin silicon nitride membrane over a cavity for thermal isolation employing a technique previously used for a thermal shear sensors.²⁶ The film could be platinum, gold, chromium, titanium, graphite, and other conducting materials. The heaters can also be fabricating using screen-printing, air-brushing, and other commercial techniques. The electronic addressing and control will be implemented by using a microcontroller mounted on a custom PCB, which also serves as the platform for the overall hybrid system. This modular approach is expected to realize a manufacturable process, and leading to simultaneous high-throughput detection of analytes.

### Example 3

Using four toxins, namely ricin (RN), cholera toxin (CT), Staphylococcus enterotocin B (SEB), and exotoxin A from Pseudomonas aeruginosa (EA), detection conditions are tested using a microfluidic-enabled antibody microarray system.

In the format shown in FIG. 1, horizontal channels are pretreated to activate the plastic surface. Capture antibodies specific to RN and CT are allowed to flow through horizontal channel 1 for binding to the wall surface, while capture antibodies specific to SEB and EA flow through horizontal channel 3. Horizontal channel 2 functions as the negative control. Known concentrations of the four toxins are then passed through the three vertical channels, allowing specific binding of antigen (Ag) by the capture antibody (Ab). Following washes, fluorescent dye-labeled detection antibody to RN and SEB (Ab-RN and Ab-SEB) are allowed to pass through the vertical channel 1 while Ab-CT and Ab-EA passes through the vertical channel 3. Vertical channel 2 also functions as the negative control. Fluorescent signals should be generated at the intersections if there were specific Ab-Ag interactions while the signal from the negative controls is used to reduce the false-positives and as the background for quantification. Fluorescent signals are detected by a charge-coupled device (CCD) camera.

For a given toxin, both capture and detection Abs can be prepared from the same polyclonal Ab, or use two monoclonal Abs that recognize two separate epitopes of the toxin. Adjustments can be made in the concentrations of capture and detection antibodies to achieve maximum detection sensitivity without compromising detection specificity. Flow rate of the reagents can also be adjusted to allow maximum Ab-Ag binding. Finally, composition of the washing solution as well as washing time can be optimized to minimize the background signal.

Other embodiments pertain to (i) devices with greater array density; (ii) detection of a comprehensive panel of toxins; (iii) multiple toxin detection from a mixture; (iv) detection of the toxins in various food and environmental samples, such as ground beef, vegetables, milk, juices and waters; and (v) detection of viruses and bacteria. These are all enabled and included as additional embodiments.

### REFERENCES

1. Anderson, R. C.; Bogdan, G. J.; Push, A.; Su, X. Genetic Analysis Systems: Improvements and Methods. Solid-State Sensor and Actuator Workshop; Transducer Research Foundation: Hilton Head Island, S.C., 1998; pp 7-10.
2. Lagally, E. T.; Medintz, I.; Mathies, R. A. Single-molecule DNA amplification and analysis in an integrated microfluidic device. Anal Chem 2001, 73, 565-570.
3. Chen, Z.; Wang, J.; Qian, S.; Bau, H. H. Thermally-actuated, phase change flow control for microfluidic systems. Lab Chip 2005, 5, 1277-1285.
4. Liu, Y.; Rauch, C. B.; Stevens, R. L.; Lenigk, R.; Yang, J.; Rhine, D. B.; Grodzinski, P. DNA amplification and hybridization assays in integrated plastic monolithic devices. Anal Chem 2002, 74, 3063-3070.
5. Liu, R. H.; Yang, J. N.; Lenigk, R.; Bonanno, J.; Grodzinski, P. Self-contained, fully integrated biochip for sample preparation, polymerase chain reaction amplification, and DNA microarray detection. Analytical Chemistry 2004, 76, 1824-1831.
6. Pal, R.; Yang, M.; Johnson, B. N.; Burke, D. T.; Burns, M. A. Phase change microvalve for integrated devices. Anal Chem 2004, 76, 3740-3748.
7. Unger, M. A.; Chou, H. P.; Thorsen, T.; Scherer, A.; Quake, S. R. Monolithic microfabricated valves and pumps by multilayer soft lithography. Science 2000, 288, 113-116.
8. Thorsen, T.; Maerkl, S. J.; Quake, S. R. Microfluidic large-scale integration. Science 2002, 298, 580-584.
9. Koh, C. G.; Tan, W.; Zhao, M. Q.; Ricco, A. J.; Fan, Z. H. Integrating polymerase chain reaction, valving, and electrophoresis in a plastic device for bacterial detection. Anal Chem 2003, 75, 4591-4598.
10. Beebe, D. J.; Moore, J. S.; Bauer, J. M.; Yu, Q.; Liu, R. H.; Devadoss, C.; Jo, B. H. Functional hydrogel structures for autonomous flow control inside microfluidic channels. Nature 2000, 404, 588-590.
11. Auroux, P. A.; Koc, Y.; deMello, A.; Manz, A.; Day, P. J. Miniaturised nucleic acid analysis. Lab Chip 2004, 4, 534-546.
12. Soper, S. A.; Ford, S. M.; Qi, S.; McCarley, R. L.; Kelly, K.; Murphy, M. C. Polymeric microelectromechanical systems. Anal Chem 2000, 72, 642A-651A.
13. Fan, Z. H.; York, P.; Cherukuri, S. Chip fabrication for combinatorial chemistry. Microstructures and microfabricated systems; The Electrochemical Society, Inc.: Pennington, N.J., 1997; pp 86-93.
14. Fan, Z. H.; Mangru, S.; Granzow, R.; Heaney, P.; Ho, W.; Dong, Q.; Kumar, R. Dynamic DNA hybridization on a chip using paramagnetic beads. Anal Chem 1999, 71, 4851-4859.
15. Fan, Z. H.; Tan, W.; Tan, H.; Qiu, X. C.; Boone, T. D. et al. Plastic microfluidic devices for DNA sequencing and protein separations. In Micro Total Analysis Systems; Ramsey, J. M., van den Berg, A. Eds.; Kluwer Academic Publishers: Netherlands, 2001; pp 19-21.
16. Boone, T. D.; Fan, Z. H.; Hooper, H. H.; Ricco, A. J.; Tan, H.; Williams, S. J. Plastic advances microfluidic devices. Anal Chem 2002, 74, 78A-86A.
17. Tan, W.; Fan, Z. H.; Qiu, C. X.; Ricco, A. J.; Gibbons, I. Miniaturized capillary isoelectric focusing in plastic microfluidic devices. Electrophoresis 2002, 23, 3638-3645.
18. Stoyanov, A. V.; Das, C.; Fredrickson, C. K.; Fan, Z. H. Conductivity properties of carrier ampholyte pH gradients in isoelectric focusing. Electrophoresis 2005, 26, 473-479.
19. Das, C.; Xia, Z.; Stoyanov, A.; Fan, Z. H. A laser-induced fluorescence imaging system for isoelectric focusing. Instrumentation Science and Technology 2005, 33, 379-389.
20. Senturia, S. D. Microsystem design; Kluwer Academic Publishers: Boston, 2001; 689.
21. Arnold, D. P.; Nishida, T.; Cattafesta, L. N.; Sheplak, M. A directional acoustic array using silicon micromachined piezoresistive microphones. Journal of the Acoustical Society of America 2003, 113, 289-298.
22. CDC (The Centers for Disease Control and Prevention); www.bt.cdc.gov/agent/agentlist-category.asp, 2005.
23. van der Linden, H.; Olthuis, W.; Bergveld, P. An efficient method for the fabrication of temperature-sensitive hydrogel microactuators. Lab Chip 2004, 4, 619-624.
24. Reyes, D. R.; Iossifidis, D.; Auroux, P. A.; Manz, A. Micro total analysis systems. 1. Introduction, theory, and technology. Anal Chem 2002, 74, 2623-2636.
25. Fredrickson, C. K.; Xia, Z.; Das, C.; R. Ferguson; Tavares, F. T.; Fan, Z. H. Effects of Fabrication Process Parameters on the Properties of Cyclic Olefin Copolymer Microfluidic Devices. Journal of Microelectromechanical Systems 2006, 15, 1060-1068.
26. Chandrasekaran, V.; Cain, A.; Nishida, T.; Cattafesta, L. N.; Sheplak, M. Dynamic calibration technique for thermal shear-stress sensors with mean flow. Experiments in Fluids 2005, 39, 56-65.

While the principles of the invention have been made clear in illustrative embodiments, there will be immediately apparent to those skilled in the art, in view of the teachings herein, many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

The references referred to herein are incorporated herein in their entirety to the extent they are not inconsistent with the teachings herein.

What is claimed is:

1. A microfluidic device comprising:
a substrate;
a first set of fluidic channels provided in said substrate;
a second set of fluidic channels provided in said substrate and arranged to intersect said first set of fluidic channels such that fluid communication occurs between intersecting channels from said first set and said second set at corresponding sites of intersection;
a first set of valves placed along at least two fluidic channels from said first set at between at least two sites of intersection and a second set of valves placed along at least two channels from said second set of fluidic channels at between at least two sites of intersection, and
an actuator for actuating said valves that is integrated into the microfluidic device.

2. The microfluidic device of claim 1, wherein said valves comprise a membrane adjacent to respective placements of valves along said first fluidic channel and said second fluidic channel, and a thermal-sensitive material adjacent to said membrane on a side membrane opposite to said respective placements and wherein said actuator comprises a heater in thermal contact with said thermal-sensitive material.

3. The microfluidic device of claim 1, wherein said valves comprise an electrostatic material adjacent to respective placements of valves along said first fluidic channel and said second fluidic channel, and the electrostatic material is placed adjacent to said actuator and wherein said actuator comprises a metal trace or pad for electronic conduction.

4. The microfluidic device of claim 1, wherein said valves comprise a membrane adjacent to respective placements of valves along said first fluidic channel and said second fluidic channel, and said actuator is adjacent to said membrane on a side membrane opposite to said respective placements and wherein said actuator is electronically actuated.

5. The microfluidic device of claim 1, wherein said valves are actuated by piezoelectric motion, electroactive polymers, and electrostatic attraction.

6. The substrate of claim 1 include but not limited to plastic materials including polystyrene, polymethylmethacrylate (PMMA), polyethylene, polyethylene, polythylene terephthalate polycarbonate, polydimethylsiloxane (PDMS), poly(cyclic olefin), polyethylene vinyl acetate, polypropylene, polycarbonates, teflon, fluorocarbons, nylon, and a variety of copolymers. Other materials include: glass, silicon, quartz, and polysilicates.

7. The heater of claim 2 is fabricated using patterned thin film metals that include platinum, gold, chromium, titanium, graphite, and other conducting materials. The heaters can also be fabricating using screen-printing, air-brushing, and other commercial techniques.

8. The actuator of claim 1 is controlled by a printed circuit board containing the control (sense and actuate) and data processing electronics which may be in close proximity to the fluidic channel including accomplishing the sealing of said fluidic channel or cavity.

9. A method for simultaneously detecting multiple analytes comprising
(a) obtaining a microfluidic device comprising a first set of channels that intersect a second set of channels; a first set of valves positioned along said first set of channels for controlling flow to and from intersecting channels; a second set of valves positioned along said second set of channels for controlling flow to and from intersecting channels;
(b) administering a first group of at least two different capture reagents populations specific to a first and second analyte into a first channel from said first set, while said second set of valves is in a closed position;
(c) administering a second group of at least two different capture reagents specific to a third and fourth analyte into a second channel from said first set, while said second set of valves is in a closed position;
(d) administering a sample into all channels from said second set while said first set of valves is in a closed position; and
(d) administering a third group of at least two different detection reagents specific to said first and third analyte into a first channel from said second set, while said first set of valves is in a closed position;
(e) administering a fourth group of at least two different detection reagents specific to said second and fourth analyte into a second channel from said second set, while said first set of valves is in a closed position; and
(f) determining whether said first, second, third, and/or fourth analyte is present in said sample based on where analyte is detected on said microfluidic device.

10. The method of claim 9, wherein said at least two different capture reagents are selected from the group consisting of primary antibody, streptavidin, avidin, biotin, DNA, DNA oligomers, poly(thymine nucleotides), aptamers, peptides, carbohydrates and glycosphingolipids, and the molecules that capture compounds, cells, and particles.

11. The method of claim 9, wherein said sample is selected from the group consisting of toxic agents, toxins, environmental hazards, small molecule chemicals, proteins, antigens, ligands, and other analytes recognized by immunological interactions; deoxyribonucleic acids (DNA), ribonucleic acids (RNA), and the like recognized by complimentary nucleic acids; the compounds recognized by aptamers, peptides, carbohydrates and glycosphingolipids; and biological cells, bacteria, virus, particles, and the materials recognized by these specific interactions.

12. The method of claim 9, wherein said at least two different detection reagents are selected from the group consisting of second antibody, streptavidin, avidin, biotin, DNA, DNA oligomers, aptamers, peptides, carbohydrates, and the molecules that recognize the analytes.

13. The method of claim 12 wherein said detection reagents comprise a moiety to facilitate detection via fluorescence, spectroscopy, luminescence, radioactive methods, and electrochemical methods.

14. A microfluidic device comprising:
a substrate;
at least one first fluidic channel provided in said substrate in a first direction;
at least one second fluidic channel provided in said substrate and arranged to intersect said at least one first fluidic channel such that fluid communication occurs between said at least one first and second channels at a site of intersection;
at least one first valve placed along said at least one first fluidic channel and
an actuator for actuating said at least one first valve, the actuator being integrated into the microfluidic device;
wherein said at least one valve comprises a membrane adjacent to said first fluidic channel and a thermal-sensitive material adjacent to said membrane; and
wherein said actuator comprises a heater in thermal contact with said thermal-sensitive material.

15. The microfluidic device of claim 14, further comprising at least one second valve placed along said at least one second fluidic channel, and an actuator for actuating said at least one second valve that is integrated into the microfluidic device.

16. The microfluidic device of claim 15, wherein said at least one first valve and at least one second valve are placed at said site of intersection so as to control fluid communication between said at least one first and second channels.

17. A microfluidic device comprising:
a substrate;
at least one first fluidic channel provided in said substrate in a first direction;
at least one second fluidic channel provided in said substrate and arranged to intersect said at least one first fluidic channel such that fluid communication occurs between said at least one first and second channels at a site of intersection;
at least one first valve placed along said at least one first fluidic channel and
an actuator for actuating said at least one first valve, the actuator being integrated into the microfluidic device;
wherein said at least one valve comprises an electrostatic material adjacent to said first fluidic channel and wherein said actuator comprises a metal trace or pad for electronic conduction adjacent to said electrostatic material.

18. A microfluidic device comprising:
a substrate;
at least one first fluidic channel provided in said substrate in a first direction;
at least one second fluidic channel provided in said substrate and arranged to intersect said at least one first fluidic channel such that fluid communication occurs between said at least one first and second channels at a site of intersection;
at least one first valve placed along said at least one first fluidic channel and
an actuator for actuating said at least one first valve, the actuator being integrated into the microfluidic device; wherein said actuator is electronically actuated.
